(19) United States
(12) Patent Application Publication
(10) Pub. No.: US 2022/0037060 A1
(43) Pub. Date: Feb. 3, 2022

(54) MOLDED WIRING HARNESS DEVICE AND METHOD THEREFOR

(71) Applicant: iLux electric (Cablage Kumar Inc.), Disraeli (CA)

(72) Inventors: Rajeev Kumar, Disraeli (CA); Rakesh Kumar, Disraeli (CA)

(21) Appl. No.: 16/983,501

(22) Filed: Aug. 3, 2020

(51) Int. Cl. H01B 13/012

(52) U.S. Cl. CPC H01B 13/01209; H01B 13/01236

(57) ABSTRACT

There is provided a method of making a wiring device housing a wire harness for use as a connector, splitter and/or jointer. The method comprises preparing a wiring diagram of a wiring harness is prepared based on predetermined requirements. The wiring diagram comprises a visual representation of a wiring layout including a plurality of wire interconnections and a plurality of terminal common wire ends. The method comprises preparing wiring harness in accordance with the wiring diagram visual representation. The method comprises preparing a visual representation of a housing with the wiring harness housed therein. The method comprises providing a mold of a housing for the wire harness in accordance with the visual representation of the housing and mounting the wire harness to the mold for molding the housing therein to provide the device housing a wire harness providing for electrical communication of the terminal common wire end. There is provided a device obtained by this method.

### TECHNICAL FIELD

The present disclosure generally relates to wiring. More particularly, but not exclusively, the present disclosure relates to a method of making a molded wiring harness device such as a connector/splitter-jointer. Still more particularly, but still not exclusively, the present disclosure relates to a molded wiring harness device such as a connector/splitter-jointer.

### BACKGROUND

Wiring is a well-known practice for the installation of electrical wiring for residential, commercial and/or industrial purposes. The wiring process is often complex with many bundles of interconnected wire networks stacked and/or clamped usually and concealed under accessible structures for future replacement, repair and/or maintenance. In many cases wiring installations require wiring harnesses, connectors, splitters and jointers.

A wire may be a single usually cylindrical, flexible strand or rod of metal or a multistrand of braided rods within a protective sleeve. Wire gauges come in various standard sizes, as expressed in terms of a gauge number (i.e diameter size). A wiring harness is an assembly of electrical wires bound together by a durable material such as rubber, vinyl, electrical tape the like. The wires are first cut to the desired length and they may also be printed on with indicia for being identified. The ends of the wires are stripped (by removing portions of the sleeve) to expose the metal (or core) of the wires, which are fitted with any required terminals or connectors The wires are then assembled and interconnected into a harness and bound together. Connectors are fasteners used to make a tight, low-impedance connection between two or more electrical wires. Made of flame-retardant materials, wire connectors prevent wires from contacting other wires or exposed metal surfaces. A jointer provides an electrical connection for joining a branch conductor to a main conductor where the main conductor continues beyond the branch. The term “joint” is also applied where two (or more) wires are joined together, in a way which is intended to reflect the construction of the wires itself. A splitter is a device used to split a wire signal if the signal must be sent to two or more devices.

### OBJECTS

An object of the present disclosure is to provide a method of making a molded wiring harness device such as a connector/splitter-jointer

An object of the present disclosure is to provide a molded wiring harness device such as a connector/splitter-jointer.

An object of the present disclosure is to provide a kit for a method of making a molded wiring harness device such as a connector/splitter-jointer.

An object of the present disclosure is to provide a computer implemented system for use in making a wiring device housing a wire harness for use as a connector, splitter and/or jointer.

### SUMMARY

In accordance with an aspect of the present disclosure, there is provided a method of making a wiring device housing a wire harness for use as a connector, splitter and/or jointer, the method comprising: preparing a wiring diagram of a wiring harness based on predetermined requirements, the wiring diagram comprising a visual representation of a wiring layout including a plurality of wire interconnections and a plurality of terminal common wire ends; preparing a wiring harness in accordance with the wiring diagram visual representation; preparing a visual representation of a housing with the wiring harness housed therein; providing a mold of a housing for the wire harness in accordance with the visual representation of the housing; mounting the wire harness to the mold and molding the housing therein to provide the device housing a wire harness providing for electrical communication of the terminal common wire end.

In an embodiment of the method, the step of preparing a visual representation of the wiring harness comprises preparing a visual representation of wire connectors mounted to one or more of the terminal common wire ends.

In an embodiment of the method, (a) preparing a wire harness comprises coupling wire connectors to the one or more terminal common wire ends of the wiring harness; (b) preparing a visual representation of the housing comprises a visual representation of the housing with the wiring harness and the wiring connectors coupled thereto housed therein; (c) the mold of the housing is based on the visual representation of (b); (d) mounting the wire harness into the mold comprises mounting the wire harness with the wire connectors coupled thereto into the mold for molding the housing therein.

In an embodiment of the method, the molding is selected from the group consisting of injection molding and over-molding.

In an embodiment of the method, the wiring diagram comprises codes for indicating different wires with different gauges and different types of wires. In an embodiment of the method, the codes are selected from the group consisting of: indicia, color and a combination thereof.

In accordance with an aspect of the present disclosure, there is provided a wiring device housing a wire harness for use as a connector, splitter and/or jointer obtained by the method hereinabove.

In accordance with an aspect of the present disclosure, there is provided a wiring device for use as a connector, splitter and/or jointer, the device comprising: an outer housing comprising a main portion and branch portions extending from the main portion and defining open free ends; and an inner wire harness of interconnected wires with terminal common ends embedded within the outer housing, wherein the terminal common ends are positioned at the open free ends and adapted for electrical communication via the open free ends.

In an embodiment of the device, one or more of the terminal common wire ends are mounted to wire connectors mounted to the open free ends of the housing.

In accordance with an aspect of the present disclosure, there is provided kit for the method hereinabove, the comprising a list of possible wiring diagrams based on respective wiring requirements and a plurality of molds for the list of possible writing diagrams.

In an embodiment, the kit further comprises a plurality of wire connectors.

In accordance with an aspect of the present disclosure, there is computer implemented system for use in making a wiring device housing a wire harness for use as a connector, splitter and/or jointer based on predetermined wiring criteria, the system comprising: a controller having an associated memory of computer executable code and comprising a databank of: (i) previously stored visual representations of a plurality of the wiring diagrams as defined in the method hereinabove and based on previously stored predetermined requirements thereby providing a first digital list of matches between predetermined requirement settings respectively associated with respective wiring diagrams of the plurality of wiring diagrams; (ii) previously stored visual representations of a plurality of the housings as defined in the method hereinabove thereby providing a second digital list of matches of respective housings of the plurality of the housings associated respective matches of the first digital list of matches; a client device having a user interface and being in communication with the controller for communication client input to the controller and receiving output therefrom; wherein execution of the computer executable code provides the controller to perform in real time the computational steps: receiving input from the client device regarding wiring requirements; comparing the wiring requirements input with the previously stored predetermined requirements to identify a match therebetween based on a predetermined similarity score stored within the memory; identifying a wiring diagram based on the matched previously stored predetermined requirements based on the first digital list; identifying a housing based on the identified wiring diagram based on the second digital list; communicating the identified diagram and the identified housing to a user via the client device.

In embodiment and without limitation thereto, a wiring diagram comprises a visual representation of the physical connections and physical layout of an electrical system or circuit. It shows how the electrical wires are interconnected and can also show where fixtures and components may be connected to the system.

In an embodiment and without limitation thereto, a wire connector comprises a device for physical grouping (i.e the connection) independent free wire ends together of a terminal common wire end so that they maintain their electrical independence from each other, all the while providing to receive another terminal (male or female) with another group of wires in order to allow for the electrical communication between the two groups of wires and specifically between a wire end of one group and a wire end of another group but without.

Other objects, advantages and features of the present disclosure will become more apparent upon reading of the following non-restrictive description of illustrative embodiments thereof, given by way of example only with reference to the accompanying drawings.

### BRIEF DESCRIPTION OF THE DRAWINGS

In the appended drawings:

FIG. 1 shows a visual representation of a wiring diagram comprising a wiring harness in accordance with a non-limiting illustrative embodiment of the present disclosure;

FIG. 2 shows a visual representation of wire connectors coupled to the terminal common wire ends of the wiring harness of FIG. 1 in accordance with a non-limiting illustrative embodiment of the present disclosure;

FIG. 3 shows a visual representation of a housing with the coupled wiring harness wire connectors housed therein in accordance with a non-limiting illustrative embodiment of the present disclosure;

FIG. 4 is a perspective view of a wiring device for wiring harness in in accordance with a non-limiting illustrative embodiment of the present disclosure;

FIG. 5 is another perspective view of the wiring device of FIG. 4; and

FIG. 6 is a schematic representation of the computer implemented system for use in making a wiring device in accordance with a non-limiting illustrative embodiment of the present disclosure.

### DETAILED DESCRIPTION OF ILLUSTRATIVE EMBODIMENTS

Generally stated and in accordance with an aspect of the present disclosure, there is provided a method of making a wiring device housing a wire harness for use as a connector, splitter and/or jointer. The method comprises preparing a wiring diagram of a wiring harness is prepared based on predetermined requirements. The wiring diagram comprises a visual representation of a wiring layout including a plurality of wire interconnections and a plurality of terminal common wire ends. The method comprises preparing wiring harness in accordance with the wiring diagram visual representation. The method comprises preparing a visual representation of a housing with the wiring harness housed therein. The method comprises providing a mold of a housing for the wire harness in accordance with the visual representation of the housing and mounting the wire harness to the mold for molding the housing therein to provide the device housing a wire harness providing for electrical communication of the terminal common wire end. There is provided a device obtained by this method. There is provided kit for this method. There is provided a computer implement system for use in the making of the devices herein.

With reference to the drawings non-limiting illustrative embodiments will now be described so as to exemplify the disclosure and not limit the scope thereof.

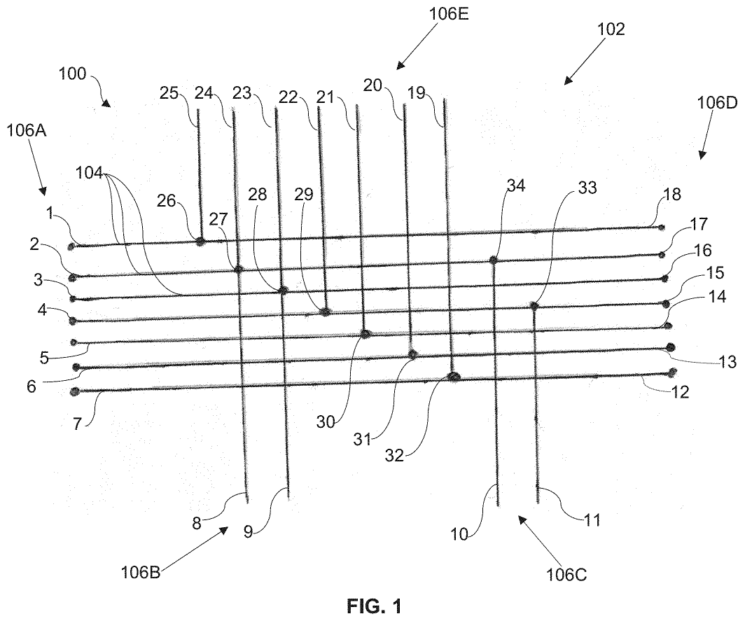

FIG. 1 shows a visual representation of a wiring diagram 100 comprising a wiring harness 102 of a plurality of wires, generally denoted by reference numeral 104 but specifically denoted 1 to 25 as will be further described herein. It is to be understood that wires herein include cables. Indeed, a wire is usually a single conductor and a cable is group of conductors (or wires). Wires/cables are made of a common material-copper or aluminum. Wires may be bare or coated with a protective layer. A wire is usually twisted. Cables can include one insulated wire or a group of wires within a protective casing. The wire harnesses herein are used in a variety of industries including and without limitation to the automobile industry, the trailer industry, the telecommunications industry, the medical industry, the aviation industry, the marine and off-road industries etc.

The wiring harness 102 is prepared based on the provided wire criteria and as such a variety of such harnesses 102 can be contemplated by the skilled artisan to correspond to a variety of requirement settings.

Thus, based on the electrical wiring requirements, the initial step of the method provided herein is prepare a visual illustration of wiring harness 102 that can meet the electrical requirements.

In the non-limiting example of FIG. 1, the visual representation or the writing harness 102 shows a plurality of interconnected wires 104 including wires 1, 2, 3, 4, 5, 6, 7 which are illustrated in different colors to represent different gauges and/or types. In this example, a set of wires 1, 2, 3, 4, 5, 6, and 7 are respectfully illustrated in orange, grey, yellow, black, green, red-white, and blue thus using color coding to indicate different gauges. Another set of wires 8, 9, 10, and 11 are respectfully represented in yellow, back, green and green-white to represent different gauges and different wire types. A further set of wires 19, 20, 21, 22, 23, 24 and 25 are respectfully illustrated in blue, red-white, red, black, black-white, grey and orange indicating different wire types. Yet another set of wires 12, 13, 14, 15, 16, 17 and 18 may be coded with other indicia for indicating different types and/or types.

The interconnection points are joints of different wires connected. For example, joint 26 interconnects wires 1, 25 and 18; joint 27 interconnects wires 2, 24, 8, and 17; joint 28 interconnects wires 3, 23, 9 and 16; joint 29 interconnects wires 4, 22 and 15; joint 30 interconnects wires 5, 21, and 14; joint 31 interconnects wires 6, 20 and 13; joint 32 interconnects wires 7, 19 and 12; joint 34 interconnects wires 2, 10 and 17; joint 33 interconnects wires 4, 11 and 15.

The wiring harness 102 defines terminal common wire ends, 106A, 106B, 106C, 106D and 106E. The terminal common wire ends 106A, 106B, 106C, 106D and 106E are the free ends of the wires 1 to 25. In this particular non-limiting example, terminal common wire end 106A comprises the free ends of wires 1 to 7; terminal common wire end 106B comprises the free ends of wires 8 and 9; terminal common wire end 106C comprises the free ends of wires 10 and 11; terminal common wire end 106D comprises the free ends of wires 12 to 18; terminal common wire end 106E comprises the free ends of wires 19 to 25.

The skilled artisan will readily appreciated that a greater or less number of wires, a greater or lesser number of joints, a greater or lesser number of terminal common wire ends can be contemplated within the scope of the present disclosure to provide a variety of wiring harnesses depending on the electrical requirements.

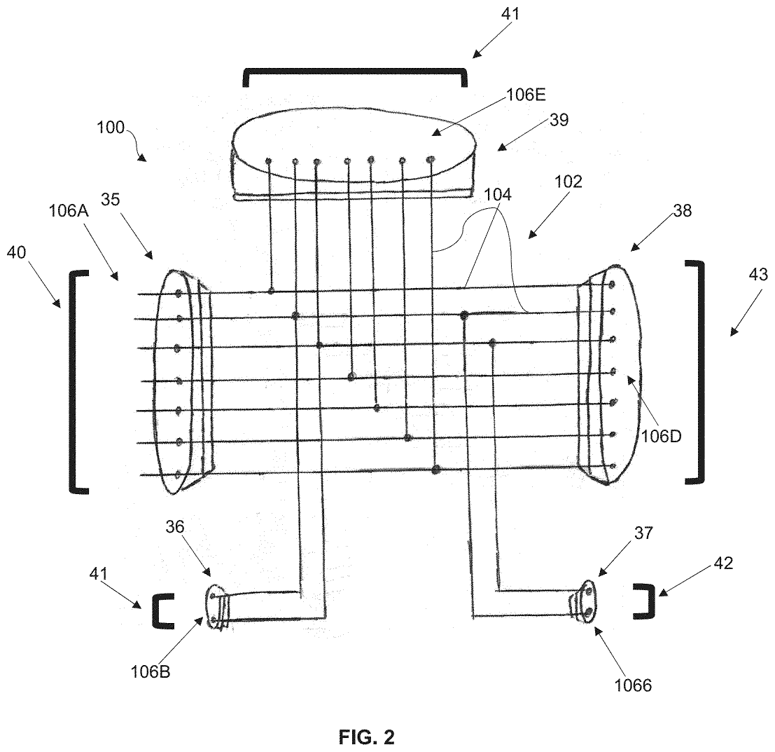

The next step of the method is to illustrate the position of the wiring connectors on the illustrated wiring harness 102. As shown in FIG. 2, the wiring connectors 35, 36, 37, 38 and 39 are respectively mounted to terminal common wire ends 106A, 106B, 106C, 106D and 106E. The wire connectors 35, 36, 37, 38 and 39 are devices that maintain the wire ends of the wires in a given terminal common wire end grouping physically grouped together but not in mutual electrical communication. The wire connectors 35, 36, 37, 38 and 39 provide for receiving respective male or female terminals 40, 41, 42, 43, and 44 to integrate the required electric network.

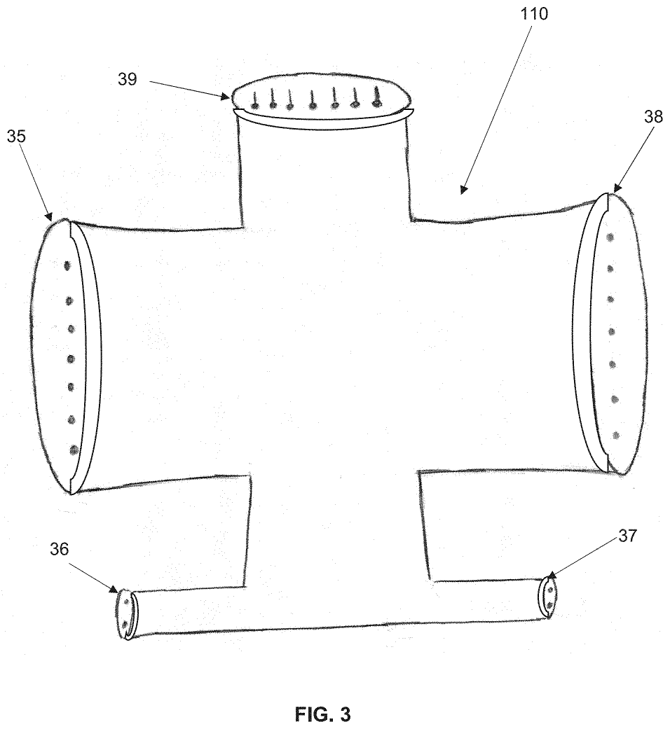

Turning to FIG. 3, once the wiring harness 102 with the wire connectors 35, 36, 37, 38 and 39 coupled thereto are illustrated, the following step consists of preparing a visual illustration of a housing 110 for housing therein the wiring harness 102 and the wire connectors 35, 36, 37, 38 and 39. The housing 110 is designed based on the shape of the wiring harness 102 and the wire connectors 35, 36, 37, 38 and 39.

The user builds the wiring harness 102 and wire connectors coupled thereto based on the prepared visual representations thereof such as those shown in FIGS. 1 and 2.

The user then provides a mold based on the visual representation thereof such as the example shown in FIG. 3.

Once the mold is provided, the user mounts therein the wiring harness 102 with the connectors coupled thereto and proceeds to mold the housing therein about the harness. Molding can be provided by injection molding or over-molding and the like.

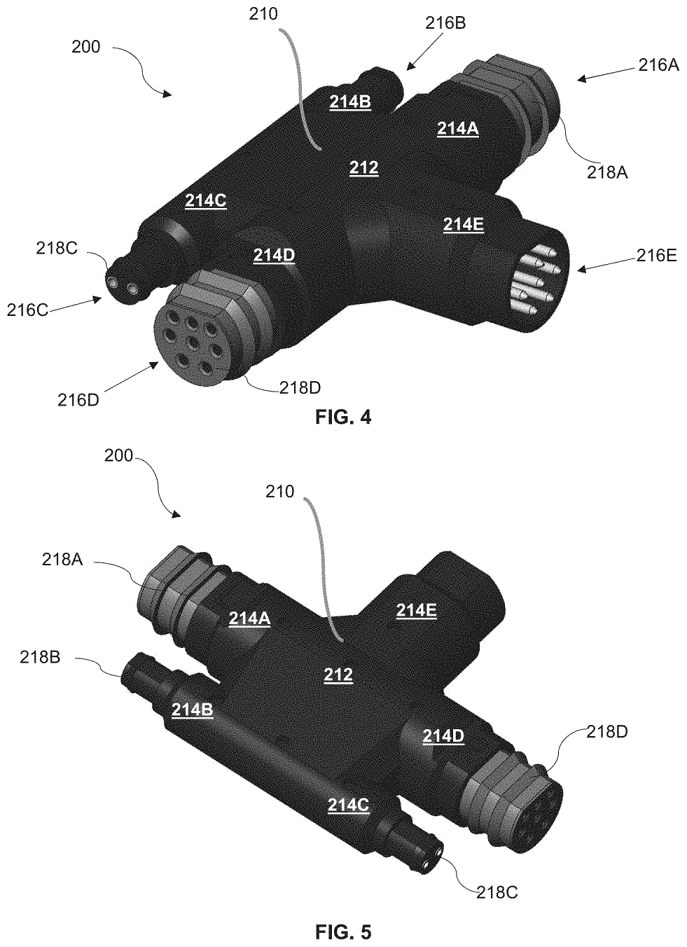

Once the molding process is completed, a wiring device 200 such as that shown in FIGS. 4 and 5 is provided. The wiring device 200 houses therein a wiring harness (such as 102) and is used as a connector/splitter-jointer. The device 200 includes an outer housing 210 with the wiring harness embedded therein and defines a main portion 212 and branch portions 214A, 214B, 214C, 214D and 214E extending therefrom and defining respective open free ends 216A, 216B, 216C, 216D and 216E, respectively. The open free ends 216A, 216B, 216C, 216D and 216E circumscribe the wire ends of each of the terminal common wire ends 106A, 106B, 106C, 106D and 106E and provide for electrical communication thereof with other conductive components, wires and devices providing device 200 to be sued as a connector/splitter-jointer. The open free ends 216A, 216C, 216D and 216E have respective wire connectors 218A, 218B, 218C, and 218D mounted thereto for being connected to respective terminals as was previously described. In this example, the open free end 216E of housing 210 does not include a wire connector. Of course, the device 200 may include one or more wire connectors or no wire connectors at all depending on the aforementioned requirements.

The housing 210 can be made of a variety of suitable materials as can be contemplated by the skilled artisan within the scope of the present disclosure.

In an embodiment, there is provided a kit for the method herein. The kit comprises a list of possible wiring diagrams based on respective wiring requirements and a plurality of molds for the list of possible writing diagrams. These lists have been assembled to provide the most common type of diagrams for building harnesses and a plurality of prefabricated molds for these types of harnesses. In an embodiment, the kit also provides a plurality of the wire connectors needs for the wiring device. As such, the user selects a requirement “code” based on pre-set requirement conditions from a predetermined list and this code corresponds to a given proposed wiring diagram and a mold that allows the user to base their wiring thereon and then use the appropriate mold for the molding step.

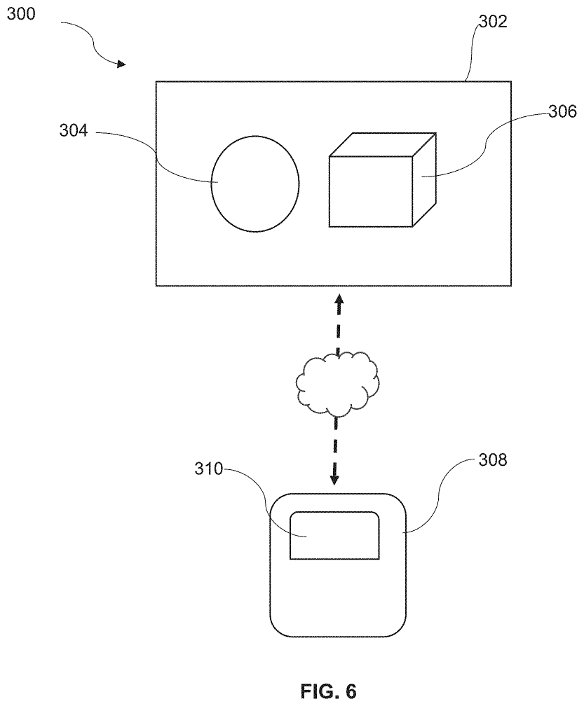

Turning now to FIG. 6, there is shown a computer implemented system 300 for use in making a wiring device such as 200 housing by way of a housing 210 for example, a wire harness such as 102 for use as a connector, splitter and/or jointer based on predetermined wiring criteria.

System 300 is shown comprising a controller 302 having an associated memory 304 of computer executable code and comprising a databank 306.

The databank 306 includes previously stored visual representations of a plurality of the wiring diagrams, such as 100 and based on previously stored predetermined requirements. In this way, the databank 306 contains a first digital list of matches between predetermined requirement settings respectively associated with respective wiring diagrams of the plurality of wiring diagrams. The databank 306 also contains previously stored visual representations of a plurality of the housings such as 110 thereby providing a second digital list of matches of respective housings of the plurality of the housings associated respective matches of the first digital list of matches.

The system 300 comprises a client device 308 having a user interface 310 and being in communication with the controller 302 for communicating client input to the controller 302 and receiving output therefrom.

Execution of the computer executable code provides the controller 302 to perform in real time computational steps. These computational steps include receiving input from the client device 308 via the interface regarding wiring requirements. The controller 302 then compares the wiring requirements input with the previously stored predetermined requirements to identify a match therebetween based on a predetermined similarity score stored within the memory. This score can be anywhere between 50%-100% shared similarity. The controller then identifies a wiring diagram based on the matched previously stored predetermined requirements based on the first digital list. The next computation step of the controller 302 is identify a housing based on the identified wiring diagram based on the second digital list. The controller 302 then communicates via the interface 310 of the client device 308 the identified diagram and the identified housing to a user. The user can then prepare a harness and mold based on the visual representation provided by the system 300. In an embodiment, the system 300 has identified a series of device such as 300 that correspond to the requirements and the user can purchase the device directly without the need of making the wiring device.

The various features described herein can be combined in a variety of ways within the context of the present disclosure so as to provide still other embodiments. As such, the embodiments are not mutually exclusive. Moreover, the embodiments discussed herein need not include all of the features and elements illustrated and/or described and thus partial combinations of features can also be contemplated. Furthermore, embodiments with less features than those described can also be contemplated. It is to be understood that the present disclosure is not limited in its application to the details of construction and parts illustrated in the accompanying drawings and described hereinabove. The disclosure is capable of other embodiments and of being practiced in various ways. It is also to be understood that the phraseology or terminology used herein is for the purpose of description and not limitation. Hence, although the present disclosure has been provided hereinabove by way of non-restrictive illustrative embodiments thereof, it can be modified, without departing from the scope, spirit and nature thereof and of the appended claims.

What is claimed is:

1. A method of making a wiring device housing a wire harness for use as a connector, splitter and/or jointer, the method comprising:
preparing a wiring diagram of a wiring harness based on predetermined requirements, the wiring diagram comprising a visual representation of a wiring layout including a plurality of wire interconnections and a plurality of terminal common wire ends;
preparing a wiring harness in accordance with the wiring diagram visual representation;
preparing a visual representation of a housing with the wiring harness housed therein;
providing a mold of a housing for the wire harness in accordance with the visual representation of the housing;
mounting the wire harness to the mold and molding the housing therein to provide the device housing a wire harness providing for electrical communication of the terminal common wire end.

2. A method according to claim 1, wherein the step of preparing a a visual representation of the wiring harness comprises preparing a visual representation of wire connectors mounted to one or more of the terminal common wire ends.

3. A method according to claim 1, wherein:
(a) preparing a wire harness comprises coupling wire connectors to the one or more terminal common wire ends of the wiring harness;
(b) preparing a visual representation of the housing comprises a visual representation of the housing with the wiring harness and the wiring connectors coupled thereto housed therein;
(c) the mold of the housing is based on the visual representation of (b);
(d) mounting the wire harness into the mold comprises mounting the wire harness with the wire connectors coupled thereto into the mold for molding the housing therein.

4. A method according to claim 1, wherein the molding is selected from the group consisting of injection molding and over-molding.

5. A method according to claim 1, wherein the wiring diagram comprises codes for indicating different wires with different gauges and different types of wires.

6. A method according to claim 5, wherein the codes are selected from the group consisting of: indicia, color and a combination thereof.

7. A wiring device housing a wire harness for use as a connector, splitter and/or jointer obtained by the method of claim 1.

8. A wiring device for use as a connector, splitter and/or jointer, the device comprising:
an outer housing comprising a main portion and branch portions extending from the main portion and defining open free ends; and
an inner wire harness of interconnected wires with terminal common ends embedded within the outer housing, wherein the terminal common ends are positioned at the open free ends and adapted for electrical communication via the open free ends.

9. A device according to claim 1, wherein one or more of the terminal common wire ends are mounted to wire connectors mounted to the open free ends of the housing.

10. A kit for the method of claim 1, comprising
a list of possible wiring diagrams based on respective wiring requirements and a plurality of molds for the list of possible writing diagrams.

11. A kit according to claim 10, further comprising a plurality of wire connectors.

12. A computer implemented system for use in making a wiring device housing a wiring harness for use as a connector, splitter and/or jointer based on predetermined wiring criteria, the system comprising:
a controller having an associated memory of computer executable code and comprising a databank of: (i) previously stored visual representations of a plurality of the wiring diagrams as defined in claim 1 based on previously stored predetermined requirements thereby providing a first digital list of matches between predetermined requirement settings respectively associated with respective wiring diagrams of the plurality of wiring diagrams; (ii) previously stored visual representations of a plurality of the housings as defined in claim 1 thereby providing a second digital list of matches of respective housings of the plurality of the housings associated respective matches of the first digital list of matches;
a client device having a user interface and being in communication with the controller for communicating client input to the controller and receiving output therefrom;
wherein execution of the computer executable code provides the controller to perform in real time the computational steps:
receiving input from the client device regarding wiring requirements;
comparing the wiring requirements input with the previously stored predetermined requirements to identify a match therebetween based on a predetermined similarity score stored within the memory;
identifying a wiring diagram based on the matched previously stored predetermined requirements based on the first digital list;
identifying a housing based on the identified wiring diagram based on the second digital list;
communicating the identified diagram and the identified housing to a user via the client device.
